(19) United States
(12) Patent Application Publication
(10) Pub. No.: US 2021/0293200 A1
(43) Pub. Date: Sep. 23, 2021

(54) Internal Combustion Engine Control Device, and Fuel Injection Valve

(71) Applicant: Hitachi Automotive Systems, Ltd., Hitachinaka-shi, Ibaraki (JP)

(72) Inventors: Yoshihiro SUKEGAWA, Tokyo (JP); Masayuki SARUWATARI, Hitachinaka-shi (JP); Ryo KUSAKABE, Tokyo (JP)

(21) Appl. No.: 17/258,352

(22) PCT Filed: Aug. 8, 2019
(86) PCT No.: PCT/JP2019/031319

§ 371 Date: Jan. 6, 2021

(30) Foreign Application Priority Data
Sep. 12, 2018 (JP) 2018-170855

(51) Int. Cl. F02D 41/40; F02D 41/06

(52) U.S. Cl. CPC F02D 41/402; F02D 2041/389; F02D 41/065; F02D 41/064

(57) ABSTRACT

Emission of unburned hydrocarbons and soot is reduced while ensuring startability (ignitability) in a cold start mode of an internal combustion engine. Thus, fuel is injected with a first injection rate as an injection rate of a fuel injection valve 100 in a warm state in which a temperature of an engine 30 is equal to or higher than a set temperature, and the fuel is injected with a second injection rate lower than the first injection rate as the injection rate of the fuel injection valve 100 in a cold state in which the temperature of the engine 30 is lower than the set temperature at the same fuel pressure as that in the warm state.

### TECHNICAL FIELD

The present invention relates to an internal combustion engine control device and a fuel injection valve.

### BACKGROUND ART

JP 2015-101986 A (PTL 1) is a background art of the present technical field. PTL 1 describes an internal combustion engine start control device that temporarily stops cranking when an engine temperature at the time of starting is lower than a predetermined temperature, forms a stratified air-fuel mixture is formed in a cylinder by performing fuel injection multiple number of times while adjusting a fuel injection amount and a fuel reaching distance such that the stratified air-fuel mixture using a required amount of fuel is formed in the same cylinder in a compression stroke, and then performs ignition by resuming the cranking.

According to the related art described in PTL 1, in the method of the related art, even though a target injection amount at the time of starting at a low temperature is increased to the extent that the injection cannot be completed during the compression stroke, it is possible to perform the ignition after the entire target injection amount is reliably injected, and it is possible to improve starting characteristics of the engine.

### CITATION LIST

### Patent Literature

PTL 1: JP 2015-101986 A

### SUMMARY OF INVENTION

### Technical Problem

At the cold start of a spark ignition engine, it is necessary to stably form a stratified air-fuel mixture in order to ensure ignitability of an air-fuel mixture by an ignition plug. Meanwhile, in order to suppress generation of unburned hydrocarbons and smoke, it is necessary to reduce adhesion of fuel to a wall surface. In general, since the formation of the stratified air-fuel mixture and the reduction of the adhesion of the fuel to the wall surface are contradictory, it is important to achieve such formation and reduction in a high balance. In order to achieve such formation and reduction in a high balance, an injection rate of a fuel injection valve (injection amount per unit time), an injection timing, and a fuel injection speed are three important control factors. However, in the related art described above, the fuel injection speed among these control factors is not considered. When the fuel injection speed is inappropriate at the cold start, stratification of the air-fuel mixture deteriorates, and thus, there is a concern that a starting time increases and emission of soot and unburned hydrocarbons deteriorates.

The present invention has been made in view of the above circumstances, and an object of the present invention is to provide an internal combustion engine control device and a fuel injection valve capable of achieving both improvement of cold startability and reduction of emission by optimizing an injection rate of a fuel injection valve, an injection timing, and a fuel injection speed at the cold start of an engine.

### Solution to Problem

In order to solve the above problems, for example, the configurations described in the claims are adopted.

The present invention includes a plurality of means for solving the problems, and as one example thereof, there is a control device including a CPU that controls a fuel injection valve which injects fuel into a cylinder of an internal combustion engine. The CPU includes a fuel injection control unit that injects the fuel with a first injection rate as an injection rate of the fuel injection valve in a warm state in which a temperature of the internal combustion engine is equal to or higher than a set temperature, and injects the fuel with a second injection rate lower than the first injection rate as the injection rate of the fuel injection valve in a cold state in which the temperature of the internal combustion engine is lower than the set temperature at the same fuel pressure as a fuel pressure in the warm state.

### Advantageous Effects of Invention

According to the present invention, it is possible to achieve both the improvement of the startability and the reduction of the emission at the cold start of the engine.

Other objects, configurations, and effects will be made apparent in the following descriptions.

### BRIEF DESCRIPTION OF DRAWINGS

FIG. 1 is a schematic diagram illustrating an internal combustion engine system and an internal combustion engine configuration according to a first embodiment of the present invention.

FIG. 2 is a vertical cross-sectional view of a fuel injection valve illustrated in the first embodiment.

FIGS. 3A and 3B illustrate a relationship between a drive current of the fuel injection valve and a needle valve displacement, in which 3A is a diagram illustrating a relationship between a drive current and a needle valve displacement during small lift control and 3B is a diagram illustrating a relationship between a drive current and a needle valve displacement during large lift control.

FIG. 4 is an enlarged vertical cross-sectional view of a nozzle tip portion of the fuel injection valve illustrated in the first embodiment.

FIGS. 5A and 5B are enlarged vertical cross-sectional views of the nozzle tip portion schematically illustrating a change in a flow of fuel when a lift amount of a needle valve varies, in which 5A is a diagram illustrating the flow of the fuel when the lift amount of the needle valve is small and 5B is a diagram illustrating the flow of the fuel when the lift amount of the needle valve is large.

FIG. 6 is a diagram illustrating a relationship between an injection rate and an injection speed with respect to the lift amount of the needle valve at the same fuel pressure.

FIG. 7 is a diagram illustrating a relationship between the injection speed and the injection rate of the fuel injection valve.

FIG. 8 is a vertical cross-sectional view of a nozzle tip portion of a fuel injection valve of the related art which throttles a fuel flow rate only by a pressure loss of a single seat portion.

FIG. 9 is a diagram illustrating a relationship between an injection rate and an injection speed when the needle valve is lifted to be low in the fuel injection valve of the related art which throttles the fuel flow rate only by the pressure loss of the single seat portion.

FIGS. 10A and 10B are vertical cross-sectional views of a nozzle tip portion of a fuel injection valve in another example of the first embodiment, in which 10A is a diagram illustrating a flow of fuel when a lift amount of a needle valve is low and 10B is a diagram illustrating a flow of fuel when the lift amount of the needle valve is high.

FIGS. 11A and 11B illustrate a relationship between a lift height of the needle valve and the injection rate, in which 11A illustrates an example in which the lift height and the injection rate of the needle valve are switched between two stages and 11B illustrates an example in which the lift height and the injection rate of the needle valve are switched between three stages.

FIG. 12 is a flowchart illustrating an engine control sequence at the engine start in the first embodiment of the present invention.

FIG. 13 is a diagram illustrating an example of an engine high output operation region at the warm start on an operation map with respect to an engine speed and a torque.

FIGS. 14A and 14B are timing charts of states of the lift amount of the needle valve, fuel injection, and ignition in a cold start mode and a warm start mode.

FIGS. 15A to 15C are timing charts of states of the lift amount of the needle valve, the fuel injection, and the ignition in the cold start mode, and are diagrams illustrating other examples of the injection form in the first embodiment of the present invention.

FIG. 16 is a diagram illustrating a control example of the injection rate with respect to a cooling water temperature (or a lubricating oil temperature) in the first embodiment of the present invention.

FIG. 17 is a diagram illustrating a control example of the number of injection divisions with respect to the cooling water temperature (or the lubricating oil temperature) in the first embodiment of the present invention.

FIG. 18 is a schematic diagram illustrating an internal combustion engine system and an internal combustion engine configuration according to a second embodiment of the present invention.

FIG. 19 is a diagram illustrating a relationship between a fuel pressure and an injection rate and between the fuel pressure and an injection speed of a fuel injection valve in the second embodiment of the present invention.

FIG. 20 is a plan view of a nozzle tip portion of the fuel injection valve in the second embodiment of the present invention, and is a diagram illustrating a difference in the number of injection holes between two fuel injection valves.

FIG. 21 is a plan view of the nozzle tip portion of the fuel injection valve in the second embodiment of the present invention, and is a diagram illustrating a difference in an injection hole diameter between two fuel injection valves.

FIG. 22 is a flowchart illustrating an engine control sequence at the engine start in the second embodiment of the present invention.

FIGS. 23A and 23B are timing charts of the fuel injection and the ignition in the cold start mode and the warm start mode.

FIGS. 24A and 24B are timing charts of the fuel injection and the ignition in the cold start mode, and are diagrams illustrating other examples of the injection form in the second embodiment of the present invention.

### DESCRIPTION OF EMBODIMENTS

Hereinafter, embodiments of the present invention will be described with reference to the drawings.

### First Embodiment

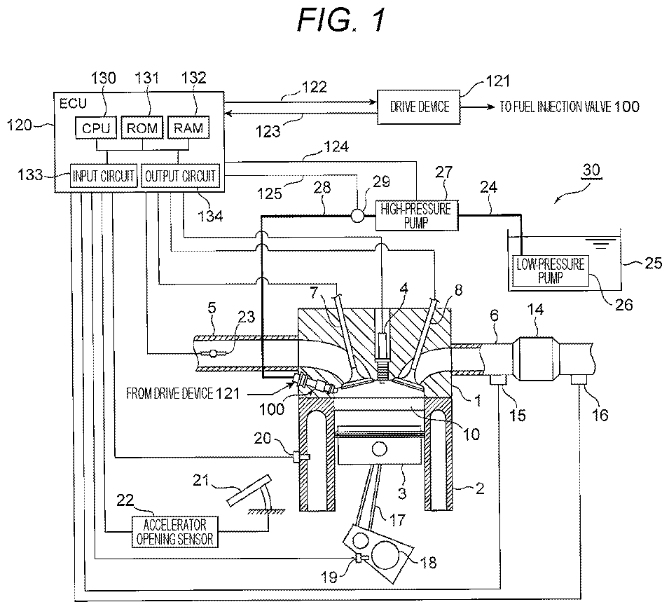

An internal combustion engine system and an internal combustion engine configuration according to a first embodiment of the present invention will be described with reference to FIG. 1.

FIG. 1 illustrates an outline of the internal combustion engine system and the internal combustion engine configuration. FIG. 1 illustrates only one cylinder of a plurality of cylinders (for example, four cylinders) normally provided in an internal combustion engine.

The internal combustion engine of the present embodiment is a 4-cycle engine (hereinafter, simply referred to as an engine) 30, and a combustion chamber 10 is formed by an engine head 1, a cylinder block 2, a piston 3, an intake valve 7, and an exhaust valve 8. A fuel injection valve 100 is provided in the engine head 1 (or may be provided in the cylinder block 2), and a nozzle tip portion penetrates the combustion chamber 10. Accordingly, a so-called cylinder direct injection engine is constructed.

The piston 3 is connected to a crankshaft 18 via a connecting rod 17, and a crank angle sensor 19 capable of detecting a crank angle and an engine speed is provided at the crankshaft 18. A water temperature sensor 20 that detects a temperature of a cooling water is provided at the cylinder block 2. A throttle valve 23 capable of adjusting the amount of air taken in is provided at an intake pipe 5, and an air flow sensor (not illustrated) capable of detecting the amount of air taken in is provided on an upstream side thereof. A three-way catalyst 14 is provided at an exhaust pipe 6, an air-fuel ratio sensor 15 is provided on an upstream side thereof, and an O₂ sensor 16 is provided on a downstream side thereof. An ignition plug that ignites an air-fuel mixture is provided at the engine head 1.

An accelerator opening sensor 22 that detects the amount that a driver steps in is provided at an accelerator pedal 21.

Fuel pressurized by a low-pressure pump 26 provided in a fuel tank 25 is sent to a high-pressure pump 27 through a low-pressure fuel pipe 24. The fuel pressurized to, for example, 5 to 50 MPa by the high-pressure pump 27 is sent to the fuel injection valve 100 through a high-pressure fuel pipe 28, and is injected from the fuel injection valve 100 into the combustion chamber 10. A fuel pressure (fuel pressure) of the high-pressure pump 27 is set by a fuel pressure command value sent from an electronic control unit (ECU) 120 which is a control device to the high-pressure pump 27 through a communication line 124.

A fuel temperature in the high-pressure fuel pipe 28 is detected by a fuel temperature sensor 29, and a fuel temperature value thereof is input to the ECU 120 through a communication line 125.

The ECU (control device) 120 includes a central processing unit (CPU) 130 that executes a calculation process according to a set program, a read-only memory (ROM) 131 that stores data necessary for a control program and calculation, a random-access memory (RAM) 132 that temporarily stores a calculation result, an input circuit 133 that receives signals from the respective sensors, an output circuit 134 that transmits signals to the respective devices based on calculation result, and the like. The ECU may be called a microcomputer including the CPU 130. Based on detection values of the respective sensors such as the accelerator opening sensor 22, the water temperature sensor 20, the air-fuel ratio sensor 15, and the O₂ sensor 16, the ECU 120 decides an injection timing, an injection period, a needle valve maximum lift amount of the fuel injection valve 100, an ignition timing of the ignition plug 4, a fuel pressure of the high-pressure pump 27, an opening degree of the throttle valve 23, and the like, transmits control signals to the respective devices, and sets the engine 30 to a predetermined operating condition. That is, the CPU 130 of the ECU 120 includes a fuel injection control unit that sets an injection rate of the fuel injection valve 100 and the like and injects fuel into the cylinder.

The fuel injection valve 100 is driven by a drive device 121. More specifically, an injection command value is sent from the ECU 120 to the drive device 121, and the drive device 121 supplies a drive current capable of opening the valve to the fuel injection valve 100 at a timing and a period corresponding to the injection command value.

The ECU 120 communicates with the drive device 121 through the communication lines 122 and 123, and it is possible to switch the drive current of the fuel injection valve 100 generated by the drive device 121 according to the operating condition and the like. More specifically, the ECU 120 is capable of changing a control constant of the drive device 121 by communicating with the drive device 121, and the drive current of the fuel injection valve 100 supplied from the drive device 121 changes according to the control constant. Although it has been described in FIG. 1 that the drive device 121 and the ECU 120 are separate members, these devices may be integrated.

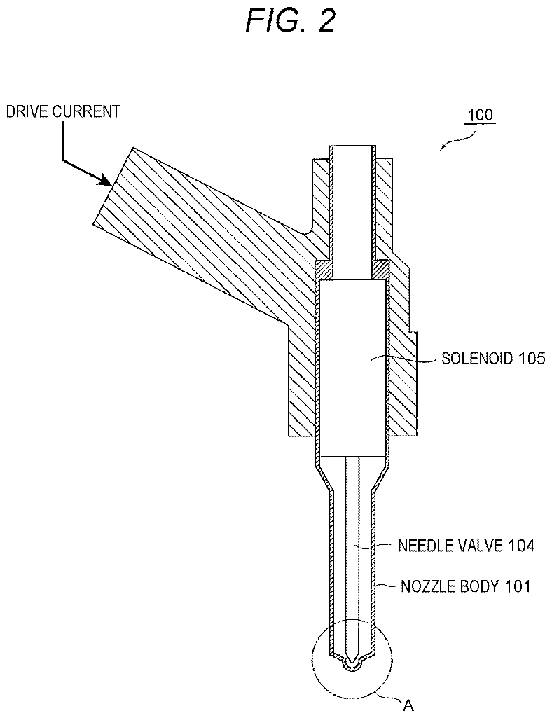

Next, a configuration and a basic operation of the fuel injection valve in the present embodiment will be described with reference to FIG. 2.

FIG. 2 illustrates a vertical cross-sectional view of the fuel injection valve 100.

The fuel injection valve 100 includes a tubular nozzle body 101, and is provided in the nozzle body 101. A needle valve 104 of which a tip has a substantially conical shape or substantially hemispherical shape is opened and closed by being driven in an axial direction by a solenoid 105. The solenoid 105 is driven by the drive current supplied from the drive device 121 to the fuel injection valve 100.

When the drive current is supplied to the solenoid 105, the needle valve 104 is lifted by a magnetic attraction force of the solenoid 105, a gap is formed between the needle valve 104 and an inner wall of the nozzle body 101, and the fuel is injected from an injection hole provided at the tip of the nozzle body 101. When the supply of the drive current to the solenoid 105 is stopped, the needle valve 104 comes into close contact with the inner wall of the nozzle body 101 due to a repulsive force of a spring (not illustrated), and the fuel injection is stopped. A lift amount (maximum lift amount) of the needle valve 104 is controlled by a magnitude of the drive current supplied to the solenoid 105.

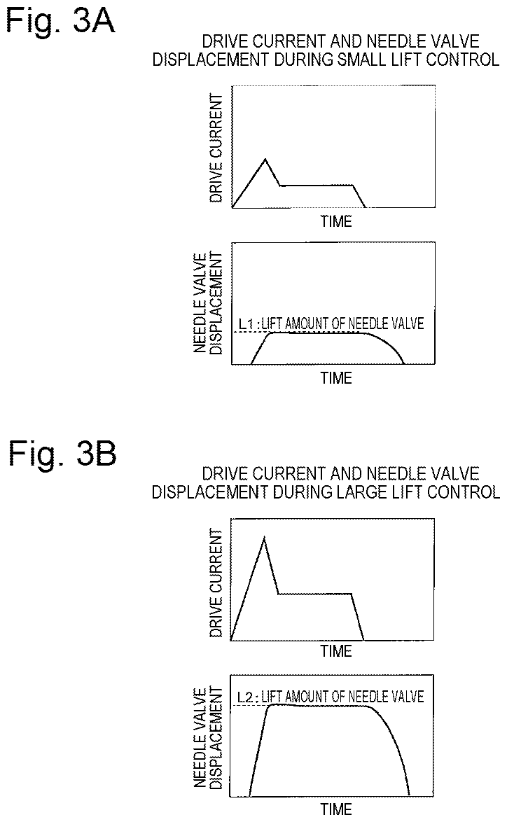

A relationship between a needle valve displacement of the fuel injection valve 100 and the drive current is illustrated in FIGS. 3(a) and 3(b). When the drive current is small, since the magnetic attraction force of the solenoid 105 is weak, a maximum lift amount L1 of the needle valve 104 is low as illustrated in FIG. 3(a). Meanwhile, when the drive current is large, since the magnetic attraction force of the solenoid 105 is strong, a maximum lift amount L2 of the needle valve 104 is high as illustrated in FIG. 3(b).

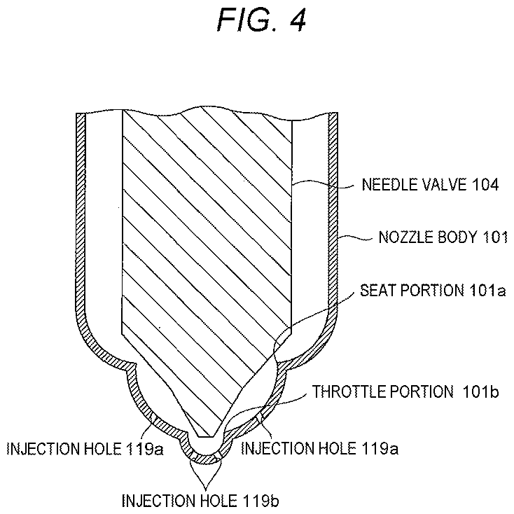

FIG. 4 illustrates an enlarged vertical cross-sectional view of the nozzle tip portion (part A in FIG. 2) of the fuel injection valve 100 in the present embodiment. As illustrated in FIG. 4, the nozzle tip portion is divided into two stages, and an inner diameter thereof becomes small. A seat portion 101a formed by a protrusion portion (first protrusion portion) provided at the inner wall of the nozzle body 101 is smaller than a diameter of the needle valve 104, and (the substantially conical or substantially hemispherical tip of) the needle valve 104 is seated on the seat portion 101a. Thus, the fuel is sealed in the nozzle body 101 (in other words, a fuel flow path is blocked), and the fuel injection is stopped.

A throttle portion 101b having an inner diameter smaller than that of the seat portion 101a is provided on a downstream side (tip side) of the seat portion 101a. In other words, the throttle portion 101b is provided on the downstream side (tip side) of the seat portion 101a such that a diameter of a circle formed by a ridgeline of a protrusion portion (second protrusion portion) provided at the inner wall of the nozzle body 101 is smaller than a diameter of a circle formed by a ridgeline of the protrusion portion (first protrusion portion) forming the seat portion 101a. Injection holes (first injection holes) 119a are provided between the seat portion 101a and the throttle portion 101b, and injection hole (second injection holes) 119b are provided on a downstream side of the throttle portion 101b.

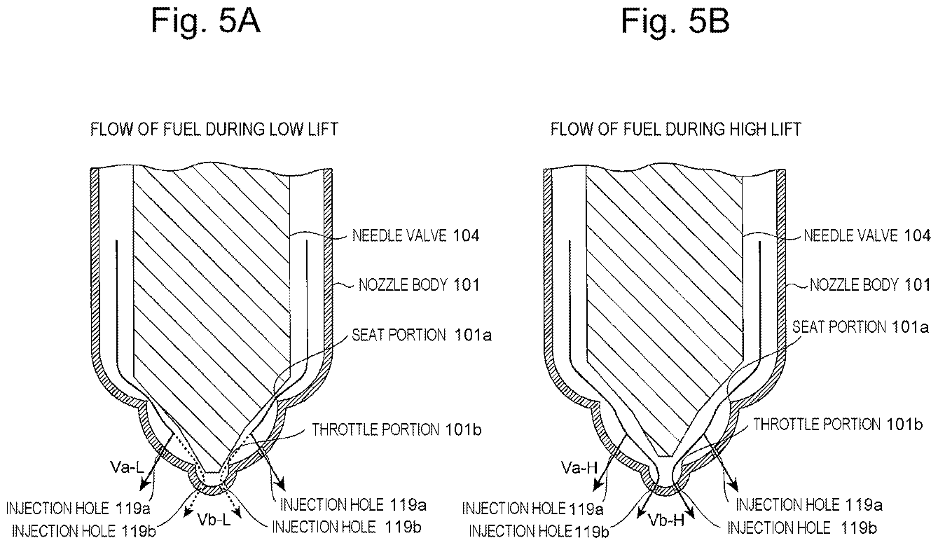

FIGS. 5(a) and 5(b) schematically illustrate a change in a flow of the fuel when a lift amount of the needle valve varies.

When the needle valve 104 has a low lift, as illustrated in FIG. 5(a), the amount of fuel injected from the injection holes 119b on the downstream side is lower than the amount of fuel injected from the injection holes 119a on the upstream side. This is because a pressure loss of the fuel flow at the throttle portion 101b is larger than a pressure loss at the seat portion 101a. That is, since the inner diameter of the throttle portion 101b is smaller than that of the seat portion 101a, a cross-sectional area of the flow path at the throttle portion is small, and the pressure loss at the throttle portion due to a throttle effect is significantly larger than that at the seat portion 101a. Thus, a flow rate of the fuel injected from the injection holes 119b is significantly smaller than a flow rate of the fuel injected from the injection holes 119a.

Meanwhile, when the lift amount of the needle valve 104 is high, as illustrated in FIG. 5(b), the flow rates of the fuel injected from the injection holes 119a on the upstream side and the fuel injected from the injection holes 119b on the downstream side are equal. This is because the pressure loss at the throttle portion 101b is almost eliminated by increasing the needle valve lift.

In addition, assuming that a fuel outflow speed from the injection holes 119a during low lift indicated in FIG. 5(a) is Va-L, a fuel outflow speed from the injection holes 119b during low lift indicated in FIG. 5(a) is Vb-L, a fuel outflow speed from the injection holes 119a during high lift indicated in FIG. 5(b) is Va-H, and a fuel outflow speed from the injection holes 119b during high lift indicated in FIG. 5(b) is Vb-H, relationships of Va-L Va-H Vb-H and Va-L>Vb-L are satisfied. That is, even though a height of the needle valve 104 is changed, the fuel outflow speed from the injection holes hardly changes. This is because a lift height of the needle valve 104 changes and an effective cross-sectional area of the injection holes (the number of effective injection holes) also changes at the same time in the fuel injection valve 100 of the present embodiment.

Specifically, when the lift height of the needle valve 104 is low and an injection flow rate is small, the effective cross-sectional area of the injection holes is small, and when the lift height of the needle valve 104 is high and the injection flow rate is large, the effective cross-sectional area of the injection holes is large (that is, as the lift amount of the needle valve 104 increases, the number of effective injection holes into which the fuel is injected increases). Accordingly, the fuel outflow speed obtained from the flow rate/the effective cross-sectional area of the injection holes is substantially constant even though the height of the needle valve 104 changes.

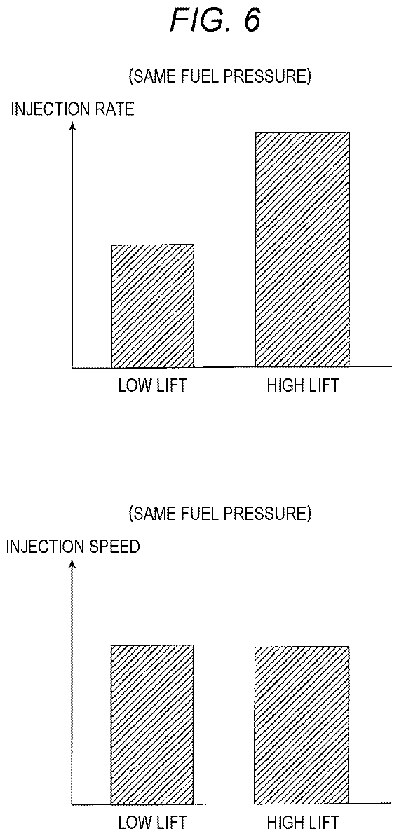

FIG. 6 illustrates a relationship between the injection rate and an injection speed with respect to the lift amount of the needle valve at the same fuel pressure. Here, the injection rate indicates an injection amount per unit time in a state in which the needle valve 104 of the fuel injection valve 100 is in a valve open state. The injection speed indicates a maximum outflow speed among the fuel outflow speeds from the plurality of injection holes.

In the fuel injection valve 100 of the present embodiment, the injection rate at the same fuel pressure can be smaller than that during high lift by controlling the lift amount of the needle valve 104 to be low. Meanwhile, the injection speeds during low lift and during high lift can be equal.

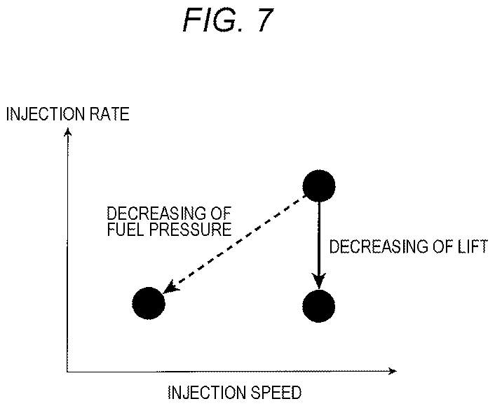

Conventionally, it is widely known that an injection rate of a fuel injection valve is changed by adjusting a fuel pressure. For example, the injection rate can be decreased by decreasing the fuel pressure. However, as illustrated by a dotted arrow in FIG. 7, when the injection rate is decreased by decreasing the fuel pressure, an injection speed is also generally decreased at the same time. That is, when the fuel pressure is decreased, the injection flow rate is decreased, but since an injection hole area of the fuel injection valve is constant, it is obvious that the injection speed indicated by the flow rate/the injection hole area is decreased.

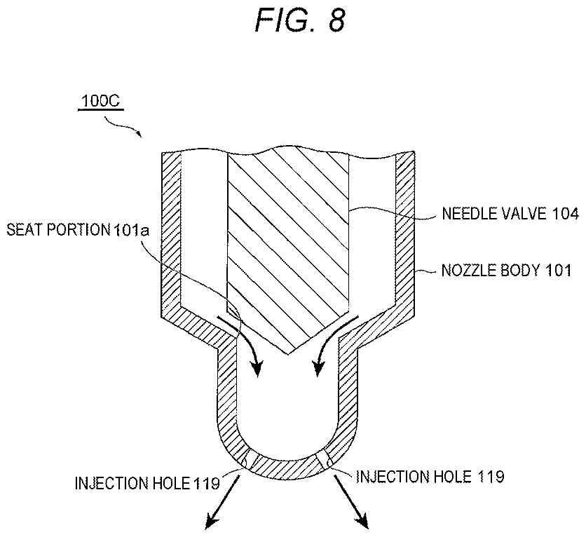

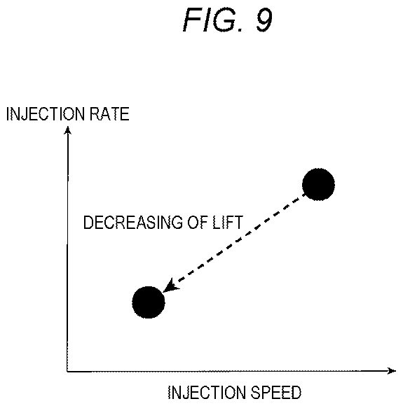

As illustrated in FIG. 8, it is widely known that an injection rate is decreased by decreasing lift of a needle valve 104 of a fuel injection valve 100C that throttles a fuel flow rate only by a pressure loss of a single seat portion 101a. However, when the lift of the needle valve 104 of the fuel injection valve 100C is decreased, the injection speed also decreases at the same time as illustrated in FIG. 9. This is because an effective cross-sectional area of injection holes 119 is constant regardless of a lift amount of the needle valve 104 and a fuel outflow speed obtained by the flow rate/the effective cross-sectional area of the injection holes is proportional to the flow rate in the fuel injection valve 100C.

In contrast, the lift amount of the needle valve 104 is set to be low (the lift is decreased) by using the fuel injection valve 100 of the present embodiment, and thus, it is possible to decrease only the injection rate while maintaining the injection speed constant as it is as indicated by a solid arrow in FIG. 7.

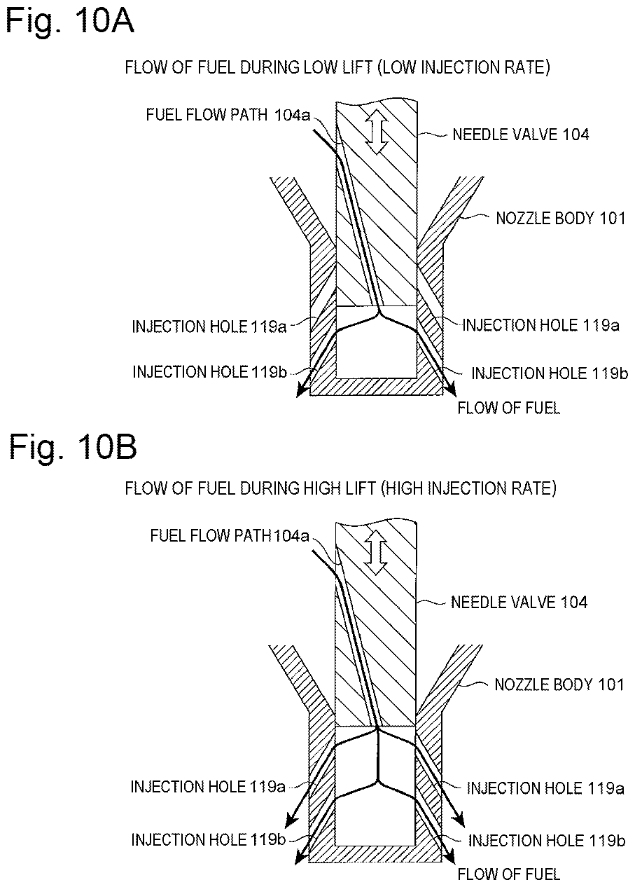

FIG. 10 illustrates another structure example of the nozzle tip portion of the fuel injection valve. In the example illustrated in FIG. 10, a plurality of injection holes 119a and 119b is provided at the nozzle body 101 along an axial direction of the nozzle body 101, and the needle valve 104 is slidably disposed at the nozzle body 101. A fuel flow path 104a penetrating the needle valve 104 is provided.

In such a fuel injection valve, when the lift amount of the needle valve 104 is low, since the injection holes 119a on the upstream side are blocked by the needle valve 104, the fuel is injected from only the injection holes 119b on the downstream side through the fuel flow path 104a of the needle valve 104 as illustrated in FIG. 10(a).

Meanwhile, when the lift amount of the needle valve 104 is high, the injection holes 119a on the upstream side and the injection holes 119 on the downstream side are in an open state, and the fuel is injected from the injection holes 119a and 119b through the fuel flow path 104a of the needle valve 104 as illustrated in FIG. 10(b).

Thus, in the fuel injection valve in this example, the injection rate at the same fuel pressure can be smaller than that during high lift by controlling the lift amount of the needle valve 104 to be low. Meanwhile, since the lift height of the needle valve 104 changes and the effective cross-sectional area of the injection holes (the number of effective injection holes) also changes at the same time, the injection speed during low lift and the injection speed during high lift can be equal.

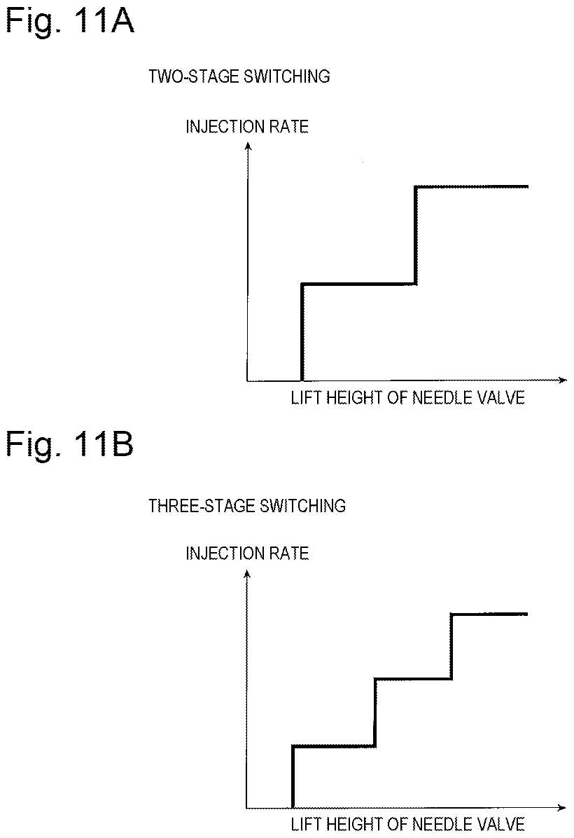

In the fuel injection valve in this example, the number of switching patterns of the injection rates can be changed by changing the number of injection holes along the axial direction of the nozzle body 101. As illustrated in FIGS. 10(a) and 10(b), when the number of injection holes along the axial direction of the nozzle body 101 is two (injection holes 119a and 119b), it is possible to switch between two types (two stages) of injection rates at the same fuel pressure by controlling the lift height of the needle valve 104 as illustrated in FIG. 11(a). For example, when the number of injection holes along the axial direction of the body 101 nozzle is three, it is possible to switch between three types (three stages) of injection rates at the same fuel pressure by controlling the lift height of the needle valve 104 as illustrated in FIG. 11(b). As stated above, the number of injection holes along the axial direction of the nozzle body 101 is increased, it is possible to increase the switching patterns of the injection rates at the same fuel pressure.

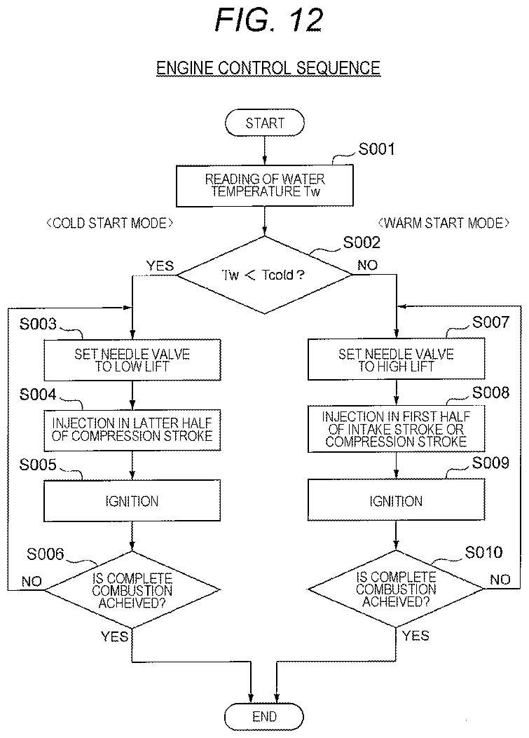

Next, an engine control sequence at the time of starting the engine in the present embodiment will be described with reference to FIG. 12. FIG. 12 is a flowchart illustrating a control procedure of the engine 30 at the time of starting the engine which is executed by the ECU 120 (fuel injection control unit of the CPU 130).

(The fuel injection control unit of the CPU 130 of) the ECU 120 of the first embodiment controls the injection rate of the fuel injection valve 100 or the like by determining whether the engine is in a cold state or a warm state and controlling the lift amount of the needle 104 of the fuel injection valve 100 already been described with reference to FIG. 4 and the like according to the state of the engine. Specifically, (the fuel injection control unit of the CPU 130 of) the ECU 120 injects the fuel with the injection rate of the fuel injection valve 100 as a first injection rate in the warm state in which a temperature of the engine 30 is equal to or higher than a set temperature, and injects the fuel with the injection rate of the fuel injection valve 100 as a second injection rate lower than the first injection rate in the cold state in which the temperature of the engine 30 is lower than the set temperature at the same fuel pressure as that in the warm state. (The fuel injection control unit of CPU 130 of) the ECU 120 injects the fuel with the injection rate of the fuel injection valve 100 as the second injection rate at least in a latter half of a compression stroke in the cold state at the same fuel pressure as that in the warm state.

Specifically, the ECU 120 reads a water temperature

Tw of the cooling water from the input of the water temperature sensor 20 in S001. Subsequently, the ECU 120 compares the water temperature Tw with a cold reference temperature Tcold in S002. The cold reference temperature Tcold is a control constant that is set in advance and is written in the ROM 131 of the ECU 120, and is, for example, 40° C. The cold reference temperature Tcold is not necessarily a constant value, and may be changed according to, for example, properties of the fuel, an outside air temperature, an atmospheric pressure, and the like.

When the water temperature Tw is lower than the cold reference temperature Tcold, the ECU 120 determines that the engine is in the cold state, and executes control of a cold start mode (S003 to S006). Meanwhile, when the water temperature Tw is equal to or higher than the cold reference temperature Tcold, the ECU 120 determines that the engine is in the warm state, and performs control of a warm start mode (S007 to S010).

In the cold start mode, the ECU 120 sets the lift amount of the needle valve 104 of the fuel injection valve 100 to a low lift side in S003. Accordingly, the ECU 120 sets the injection rate of the fuel injection valve 100 to be low (as the second injection rate). Here, the low lift indicates, for example, that the lift amount of the needle valve in the cold start mode is lower than the lift amount of the needle valve 104 in the warm start mode.

Alternatively, the low lift indicates a smallest maximum lift amount in the fuel injection valve 100 capable of switching the maximum lift amount of the needle valve 104 between a plurality of stages.

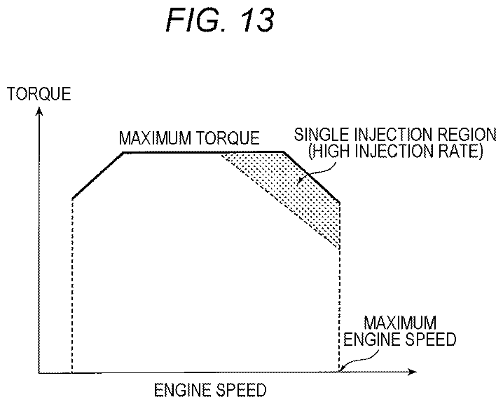

Alternatively, for example, the low lift indicates that the lift amount is lower than the lift amount of the needle valve 104 during a high engine output operation. Here, the term of during the high engine output operation indicates an operation region which is in the vicinity of a maximum torque and a maximum engine speed on an operation map for an engine speed and a torque and in which single injection (one fuel injection for each cylinder within one combustion cycle) is executed as illustrated in FIG. 13.

Subsequently, in the cold start mode, the ECU 120 injects the fuel from (the injection holes of) the fuel injection valve 100 in the latter half of the compression stroke in S004. The ECU 120 performs ignition with the ignition plug 4 in S005, and determines whether or not complete combustion is achieved in S006. The complete combustion is determined, for example, when the engine speed is equal to or higher than a predetermined engine speed (for example, 1000 rpm or higher). Alternatively, the explosion completion is determined when a pressure in the cylinder or a shaft torque is equal to or higher than a predetermined value. The processes of S003 to S006 are repeated until it is determined that the complete combustion is achieved.

When it is determined in S006 that the complete combustion is achieved, the start sequence is terminated.

Meanwhile, in the warm start mode, the ECU 120 sets the lift amount of the needle valve 104 of the fuel injection valve 100 to a high lift side in S007. Accordingly, the ECU 120 sets the injection rate of the fuel injection valve 100 to be high (as the first injection rate larger than the second injection rate). Subsequently, the ECU 120 injects the fuel from (the injection holes of) the fuel injection valve 100 in an intake stroke or in a first half of the compression stroke in S008, and executes the ignition with the ignition plug 4 in S009. The ECU 120 repeats the processes of S007 to S010 until it is determined that the complete combustion is achieved in S010. When it is determined that the complete combustion is achieved in S010, the start sequence is terminated.

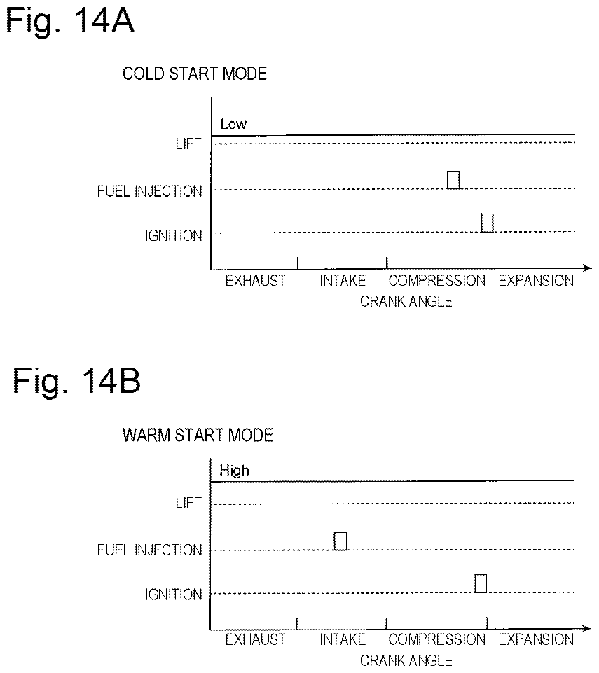

FIGS. 14(a) and 14(b) illustrate timing charts of the states of the lift amounts of the needle valve 104, the fuel injection, and the ignition in the cold start mode and the warm start mode.

In the cold start mode, the lift amount of the needle valve 104 is maintained in a low lift state, and the fuel injection from the fuel injection valve 100 is executed in the latter half of the compression stroke as illustrated in FIG. 14(a). The latter half of the compression stroke mentioned herein is the latter half of the compression stroke, that is, a range in which the crank angle is 90° to 0° before a compression top dead center. In the example illustrated in FIG. 14(a), the fuel injection in the latter half of the compression stroke of one combustion cycle is executed on the assumption that the injection rate of the fuel injection valve 100 is constant (is maintained at the second injection rate).

Meanwhile, in the warm start mode, the lift amount of the needle valve 104 is maintained in a high lift state, and the fuel injection from the fuel injection valve 100 is executed in the intake stroke (or the first half of the compression stroke) as illustrated in FIG. 14(b).

The reason why the fuel is injected in the latter half of the compression stroke in the cold start mode is that a fuel-rich air-fuel mixture, that is, a stratified air-fuel mixture is formed around the ignition plug 4.

When the fuel is injected in the latter half of the compression stroke, since the dispersion of the fuel is suppressed, the fuel can be concentrated around the ignition plug 4. Since the fuel is less likely to be vaporized in the cold start mode than in the warm start mode, when the fuel is injected at the same timing as that in the warm start mode, the fuel around the ignition plug 4 becomes a diluted air-fuel mixture, and thus, it is difficult to perform the ignition using the ignition plug 4. Thus, the stratified air-fuel mixture is formed in the cold start mode, and the dilution of the air-fuel mixture around the ignition plug 4 is prevented. Accordingly, reliable ignition is performed at a low temperature.

However, since the piston 3 rises to near a top dead center in the latter half of the compression stroke, there is a concern that the injected fuel collides with a crown surface of the piston and a fuel liquid film is formed.

The discharge of unburned hydrocarbons and soot is increased by the formation of the fuel liquid film. Thus, in the present embodiment, the formation of the fuel liquid film is suppressed by decreasing (lowering) the injection rate of the fuel injection valve 100. When the injection rate is decreased, since a penetration force of a fuel droplet decreases, the collision of the droplet with the piston crown surface and the fuel adherence are reduced, and the formation of the liquid film is suppressed.

Meanwhile, in order to form the stratified air-fuel mixture around the ignition plug 4, it is necessary to transport the vaporized fuel to the vicinity of the ignition plug 4. In the latter half of the compression stroke, since a gas flow in the cylinder generated during an intake process is attenuated and weakened, it is preferable that the gas flow generated by the fuel injection is used to transport the vaporized fuel to the vicinity of the ignition plug 4.

In order to form a necessary and sufficient gas flow by the fuel injection, it is necessary to apply a large shearing force to the gas in the cylinder from spray by high-speed fuel injection. In the present embodiment, since the fuel injection valve 100 in which the injection speed hardly changes even though the injection rate is changed is used, the sufficient gas flow for transporting the vaporized fuel to the vicinity of the ignition plug 4 can be formed even in a condition of the low injection rate.

For example, when the injection rate is lowered by decreasing the fuel pressure, the injection speed is also decreased at the same time, and the gas flow generated by the injection is weakened. Then, it is difficult to transport the vaporized fuel to the vicinity of the ignition plug 4.

That is, according to the present embodiment, in the cold start mode of the engine, it is possible to reliably form the stratified air-fuel mixture with high ignitability by injecting the fuel in the latter half of the compression stroke while suppressing the formation of the fuel liquid film (in other words, adhesion of the fuel to a wall surface) that causes the emission of unburned hydrocarbons and soot.

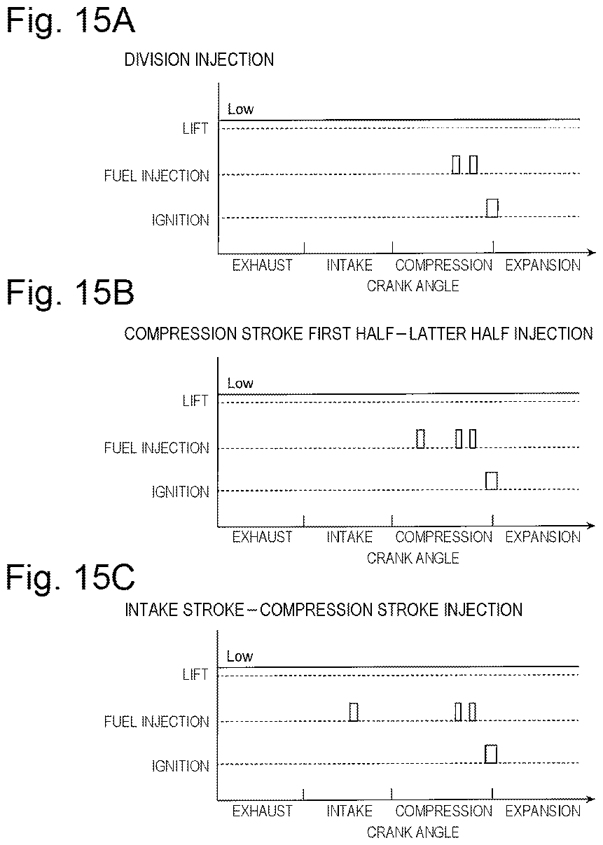

FIGS. 15(a) to 15(c) illustrate other examples of the injection form of the cold start mode according to the present embodiment.

FIG. 15(a) illustrates an example in which the fuel injection in the latter half of the compression stroke is divided. The fuel injection mentioned herein is divided, and thus, the penetration force of the fuel spray becomes smaller. Accordingly, the formation of the liquid film can be further reduced. The fuel injection is divided, and thus, local mixing of the vaporized fuel and air is promoted. Accordingly, the air-fuel ratio of the stratified air-fuel mixture around the ignition plug 4 becomes uniform. Accordingly, an effect of reducing the production of the soot and improving combustion stability (robustness) is obtained. Although it has been illustrated in FIG. 15(a) that the fuel injection in the latter half of the compression stroke is divided into two number of times, the present invention is not limited thereto, and the fuel injection may be divided into three or more number of times.

FIG. 15(b) illustrates an example in which the fuel injection in the first half of the compression stroke (180° to 90° before the compression top dead center) is added to the fuel injection in the latter half of the compression stroke. FIG. 15(c) illustrates an example in which the fuel injection in the intake stroke is added to the fuel injection in the latter half of the compression stroke. For example, even under a cold condition, when the temperature is relatively high or when the fuel vaporization is good due to light fuel, a degree of stratification of the air-fuel mixture is weakened, and it is necessary to optimize the fuel injection such that the air-fuel ratio near the ignition plug 4 is not excessively rich. In such a case, it is effective to disperse the fuel injection in the first half of the compression stroke and the intake stroke as in the examples illustrated in FIGS. 15(b) and 15(c). Although it has been illustrated in FIGS. 15(b) and 15(c) that the division injection (fuel is injected by multiple number of times) in the latter half of the compression stroke, the fuel injection in the latter half of the compression stroke may be a single injection.

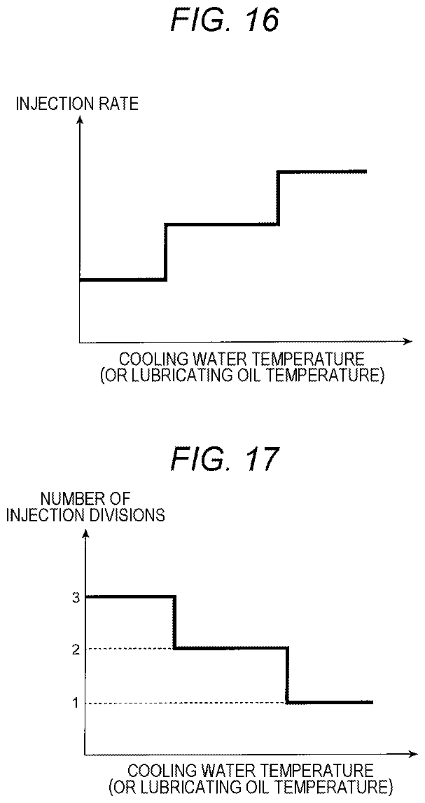

As illustrated in FIG. 16, (the fuel injection control unit of the CPU 130 of) the ECU 120 may change the injection rate of the fuel injection valve 100 in the cold start mode according to the cooling water temperature (or a lubricating oil temperature (simply referred to as an oil temperature)) of the engine 30 input from the water temperature sensor 20. For example, when the cooling water temperature is low, it is necessary to further improve the ignitability of the air-fuel mixture, and it is desirable that the degree of stratification around the ignition plug 4. Thus, it is effective to further retard the injection timing in the latter half of the compression stroke. However, in this case, since there is a concern that the formation of the fuel liquid film increases, the injection rate is set to be smaller (lower).

Meanwhile, when the cooling water temperature is relatively high, the injection timing in the latter half of the compression stroke is advanced in order to weaken the degree of stratification around the ignition plug 4. Since the formation of the fuel liquid film is suppressed as the injection timing is advanced, the injection rate can be set to a higher value.

When the injection rate is increased, there is an advantage that blockage of the injection hole of the fuel injection valve 100 can be avoided due to combustion deposit or the like. That is, when the number of fuel injections at the low injection rate increases, there is a concern that the injection hole through which the fuel injection is not executed is blocked by the combustion deposit or the like. The injection rate is finely set according to the cooling water temperature (or the lubricating oil temperature), and thus, a chance to execute the fuel injection at the high injection rate increases. Accordingly, the blockage of the injection hole can be prevented.

As illustrated in FIG. 17, (the fuel injection control unit of the CPU 130 of) the ECU 120 may change the number of injection divisions of the fuel injection valve 100 in the latter half of the compression stroke in the cold start mode according to the cooling water temperature (or the lubricating oil temperature) of the engine 30 input from the water temperature sensor 20. For example, when the cooling water temperature is low, it is necessary to further improve the ignitability of the air-fuel mixture, and it is desirable that the degree of stratification around the ignition plug 4. Thus, it is effective to further retard the injection timing in the latter half of the compression stroke. However, in this case, since there is a concern that the formation of the fuel liquid film increases, it is desirable that the number of injection divisions increases and the penetration force of the fuel spray is further decreased.

Meanwhile, when the cooling water temperature is relatively high, the injection timing in the latter half of the compression stroke is advanced in order to weaken the degree of stratification around the ignition plug 4. Since the formation of the fuel liquid film is suppressed as the injection timing is advanced, the number of injection divisions can be set to a smaller number.

When the number of injection divisions is decreased, there is an advantage that variation in the injection amount for each cycle can be reduced. In general, as an injection pulse width becomes shorter, the variation in the injection amount for each shot of the injection is increased. Thus, the injection pulse width becomes longer by reducing the number of injection divisions, and the variation in the injection amount decreases. The variation in the injection amount decreases, and thus, cycle fluctuation of the engine and a variation in the cycle between the cylinders decrease.

As described above, the ECU (control device) 120 of the first embodiment includes the CPU 130 that controls the fuel injection valve 100 that injects the fuel into the cylinder of the engine 30. The CPU 130 includes the fuel injection control unit that injects the fuel with the injection rate of the fuel injection valve 100 as the first injection rate in the warm state in which the temperature of the engine 30 is equal to or higher than the set temperature, and injects the fuel with the injection rate of the fuel injection valve 100 as the second injection rate lower than the first injection rate in the cold state in which the temperature of the engine 30 is lower than the set temperature at the same fuel pressure as that in the warn state.

As stated above, the fuel injection is executed by setting the injection rate of the fuel injection valve 100 in the cold state to be smaller (lower) than that in the warm state, and thus, it is possible to suppress the formation of the fuel liquid film that causes the emission of the unburned hydrocarbons and soot in the cold start mode of the engine. Accordingly, it is possible to improve startability and reduce the emission at the cold start of the engine.

The fuel injection control unit of the CPU 130 injects the fuel with the injection rate of the fuel injection valve 100 as the second injection rate at least in the latter half of the compression stroke in the cold state at the same fuel pressure as that in the warm state.

Accordingly, in the cold start mode of the engine, it is possible to reliably form the stratified air-fuel mixture with high ignitability by injecting the fuel in the latter half of the compression stroke while suppressing the formation of the fuel liquid film that causes the emission of unburned hydrocarbons and soot, and it is possible to achieve both the improvement of the startability and the reduction of the emission at the cold start of the engine.

The fuel injection valve 100 used in the first embodiment may be implemented in various forms, and includes, for example, the needle valve 104 provided in the nozzle body 101 so as to be movable in the axial direction, the seat portion 101a at which the fuel flow path is blocked by seating the needle valve 104 at the first protrusion portion provided at the inner wall of the nozzle body 101, the throttle portion 101b provided such that the diameter of the circle formed by the ridgeline of the second protrusion portion provided on the inner wall of the nozzle body 101 on the downstream side of the seat portion 101a is smaller than the diameter of the circle formed by the ridgeline of the first protrusion portion, the injection holes (first injection holes) 119a arranged between the seat portion 101a and the throttle portion 101b, and the injection holes (second injection holes) 119b arranged on the downstream side of the throttle portion 101b.

The lift of the needle valve 104 is decreased by using the fuel injection valve 100 having such a configuration, and thus, it is possible to decrease only the injection rate while maintaining the injection speed constant. Accordingly, it is possible to achieve both the improvement of the startability and the reduction of the emission at the cold start of the engine.

### Second Embodiment

In the first embodiment, the embodiment in which one fuel injection valve 100 is provided at the cylinder of the engine 30 and the lift height (corresponding to the injection rate) and the injection timing of the needle valve 104 of the fuel injection valve 100 are controlled in the start control of the engine has been described. Hereinafter, another embodiment (second embodiment) of the present invention will be described with reference to the drawings. In the following second embodiment, a plurality of fuel injection valves having different specifications or characteristics is provided at the cylinder of the engine and the injection rate of the fuel injected into the cylinder and the like are controlled according to the state of the engine by individually controlling (switching between) the fuel injection valves in the start control of the engine.

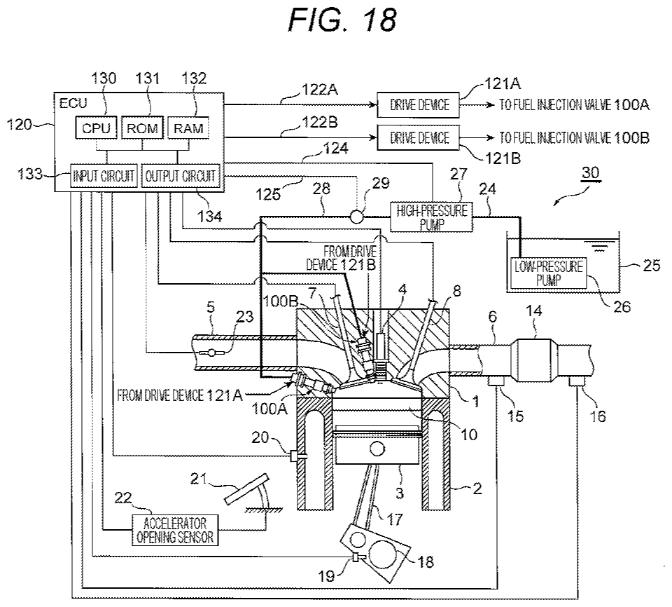

FIG. 18 illustrates an internal combustion engine system and an internal combustion engine configuration according to the second embodiment of the present invention. In the second embodiment illustrated in FIG. 18, the same reference signs are given to configurations corresponding to the configurations of the first embodiment illustrated in FIG. 1.

In the present embodiment, a fuel injection valve 100A is provided on a side of the engine head 1, and a fuel injection valve 1000B is provided on an upper portion of the engine head 1. The fuel injection valve 100A and the fuel injection valve 1000B are independently driven by a drive device 121A and a drive device 121B. The ECU 120 can control an injection timing and an injection duration time of the fuel injection valve 100A by communicating with the drive device 121A through a communication line 122A and controlling a drive current of the fuel injection valve 100A generated by the drive device 121A according to an operating condition and the like. Similarly, the ECU 120 can control an injection timing and an injection duration time of the fuel injection valve 100B by communicating with the drive device 121B through the communication line 122B and controlling a drive current of the fuel injection valve 100B generated by the drive device 121B according to an operating condition and the like.

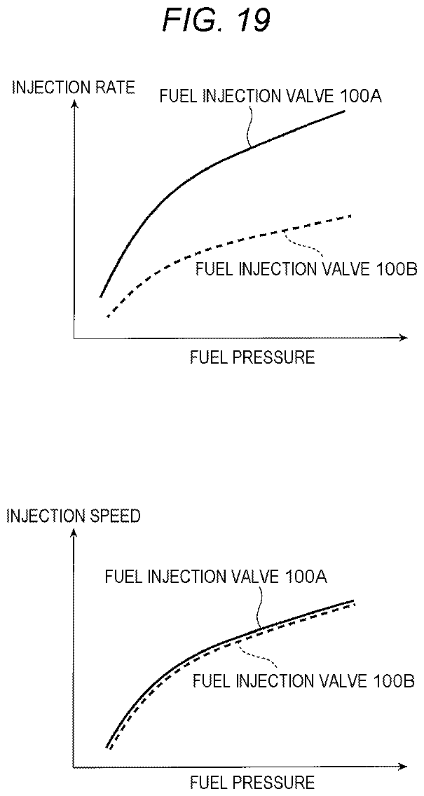

FIG. 19 illustrates injection rate characteristics of the fuel injection valve 100A and the fuel injection valve 100B with respect to the fuel pressure and injection speed characteristics with respect to the fuel pressure.

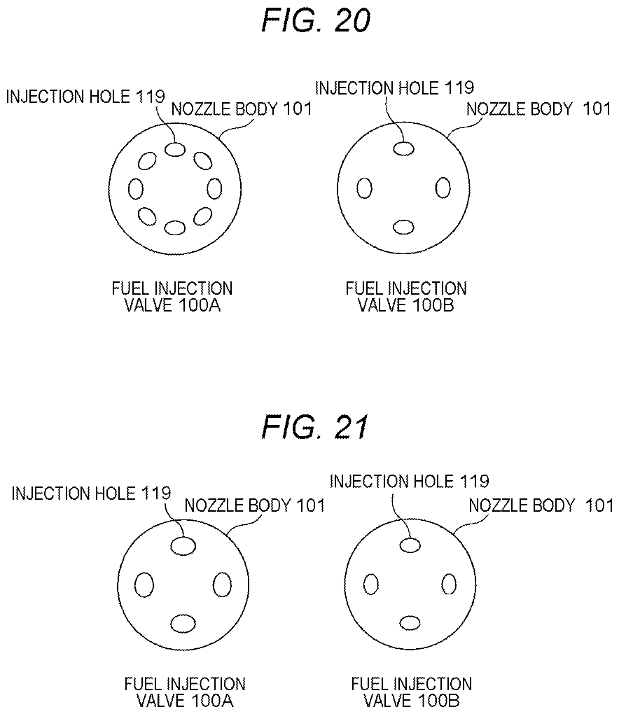

In the present embodiment, nozzle specifications of the fuel injection valves 100A and 100B are decided such that the injection rate of the fuel injection valve 100B is smaller than the injection rate of the fuel injection valve 100A and the injection speeds of the fuel injection valve 100A and the fuel injection valve 100B are almost equal in the condition of the same fuel pressure. For example, as illustrated in FIG. 20, the number of injection holes of the fuel injection valve 100B is set to be smaller than the number of injection holes of the fuel injection valve 100A. For example, as illustrated in FIG. 21, the diameter of the injection hole of the fuel injection valve 100B is set to be smaller than the diameter of the injection hole of the fuel injection valve 100A. Due to the combination thereof, the number of injection holes of the fuel injection valve 100B may be smaller than the number of injection holes of the fuel injection valve 100A, and the diameter of the injection hole of the fuel injection valve 100B may be smaller than the diameter of the injection hole of the fuel injection valve 100A.

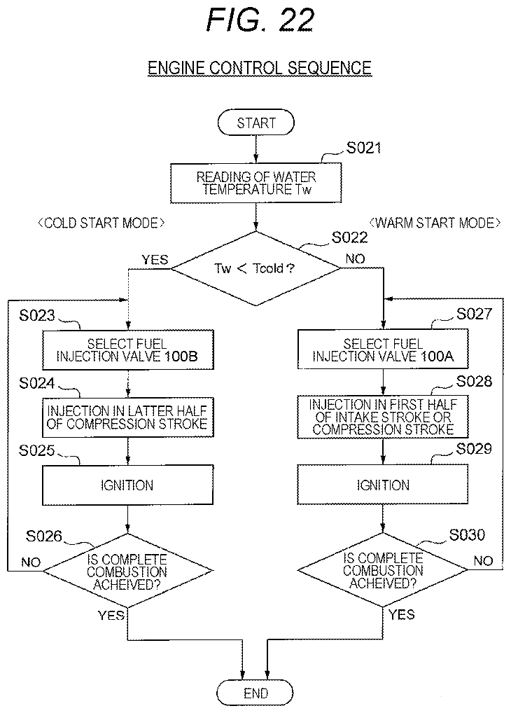

Next, an engine control sequence at the time of starting the engine in the present embodiment will be described with reference to FIG. 22. FIG. 22 is a flowchart illustrating a control procedure of the engine 30 at the time of starting the engine which is executed by (the fuel injection control unit of the CPU 130 of) the ECU 120.

(The fuel injection control unit of the CPU 130 of) the ECU 120 of the second embodiment controls the injection rate of the fuel injected into the cylinder by determining whether the engine is in the cold state or the warm state and individually controlling the opening and closing of the fuel injection valves 100A and 100B already been described with reference to FIG. 19 and the like according to the state of the engine.

Specifically, (the fuel injection control unit of the CPU 130 of) the ECU 120 injects the fuel (with the first injection rate) by operating the fuel injection valve 100A in the warm state in which the temperature of the engine 30 is equal to or higher than a set temperature, and injects the fuel (with the second injection rate lower than the first injection rate) by operating the fuel injection valve 100B in the cold state in which the temperature of the engine 30 is lower than the set temperature at the same fuel pressure as that in the warm state.

(The fuel injection control unit of the CPU 130 of) the ECU 120 injects the fuel by operating the fuel injection valve 100B at least in the latter half of the compression stroke in the cold state at the same fuel pressure as that in the warm state.

Specifically, the ECU 120 reads the water temperature Tw of the cooling water from the input of the water temperature sensor 20 in S021. Subsequently, the ECU 120 compares the water temperature Tw with the cold reference temperature Tcold in S022. When the water temperature Tw is lower than the cold reference temperature Tcold, the ECU 120 determines that the engine is in the cold state, and executes the control of the cold start mode (S023 to S026). Meanwhile, when the water temperature Tw is equal to or higher than the cold reference temperature Tcold, the ECU 120 determines that the engine is in the warm state, and executes the control of the warm start mode (S027 to S030).

In the cold start mode, the ECU 120 selects the fuel injection valve 100B as the fuel injection valve that executes the fuel injection in this mode in S023. Accordingly, the ECU 120 sets the injection rate to be low (as the second injection rate). Subsequently, the ECU 120 injects the fuel from (the injection holes of) the fuel injection valve 100B in the latter half of the compression stroke in S024. The ECU 120 performs ignition with the ignition plug 4 in S025, and determines whether or not complete combustion is achieved in S026. The processes of S023 to S026 are repeated until it is determined that the complete combustion is achieved. When it is determined that the complete combustion is achieved in S026, the start sequence is terminated.

Meanwhile, in the warm start mode, the ECU 120 selects the fuel injection valve 100A as the fuel injection valve that executes the injection in this mode in S027. Accordingly, the ECU 120 sets the injection rate to be high (as the first injection rate larger than the second injection rate). Subsequently, the ECU 120 injects the fuel from (the injection holes of) the fuel injection valve 100A in the first half of the intake stroke or the compression stroke in the S028. The ECU 120 performs ignition with the ignition plug 4 in S029, and determines whether or not complete combustion is achieved in S030. The processes of S027 to S030 are repeated until it is determined that the complete combustion is achieved. When it is determined that the complete combustion is achieved in S030, the start sequence is terminated.

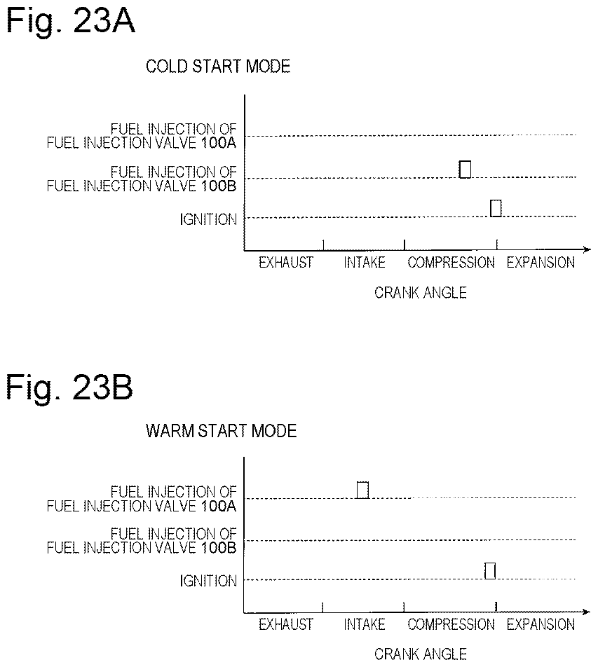

FIGS. 23(a) and 23(b) illustrate timing charts of the fuel injection and the ignition in the cold start mode and the warm start mode.

In the cold start mode, the fuel injection is executed in the latter half of the compression stroke earlier than the fuel injection valve 100B in which the injection rate is set to be lower in the condition of the same fuel pressure as illustrated in FIG. 23(a). The latter half of the compression stroke mentioned herein is the latter half of the compression stroke, that is, a range in which the crank angle is 90° to 0° before a compression top dead center.

Meanwhile, in the warm start mode, the fuel injection is executed in the intake stroke (or the first half of the compression stroke) earlier than the fuel injection valve 100A in which the injection rate is set to be high in the condition of the same fuel pressure as illustrated in FIG. 23(b).

That is, in the present embodiment, two fuel injection valves 100A and 100B having different injection rates in the case of the same lift amount are attached to the engine 30. (The fuel injection control unit of the CPU 130 of) the ECU 120 executes the fuel injection by operating the fuel injection valve 100B having the low injection rate of the two fuel injection valves 100A and 100B in the latter half of the compression stroke in the cold start mode, executes the fuel injection by operating the fuel injection valve 100A having the high injection rate of the two fuel injection valves 100A and 100B in the intake stroke or the first half of the compression stroke in the warm start mode, and executes the fuel injection in the latter half of the compression stroke and the fuel injection in the first half of the compression stroke or the intake stroke by another fuel injection valve.

The fuel dispersion can be suppressed by executing the fuel injection in the latter half of the compression stroke in the cold start mode. The fuel injection from the fuel injection valve 100B having the low injection rate, and thus, the formation of the liquid film on the crown surface of the piston is suppressed. Since the fuel injection valve 100B has the low injection rate but has an injection speed equivalent to that of the fuel injection valve 100A having the high injection rate, the sufficient gas flow for transporting the vaporized fuel to the vicinity of the ignition plug 4 can be formed. That is, according to the present embodiment, in the cold start mode of the engine, it is possible to reliably form the stratified air-fuel mixture with high ignitability by injecting the fuel in the latter half of the compression stroke while suppressing the formation of the fuel liquid film (in other words, adhesion of the fuel to a wall surface) that causes the emission of unburned hydrocarbons and soot.

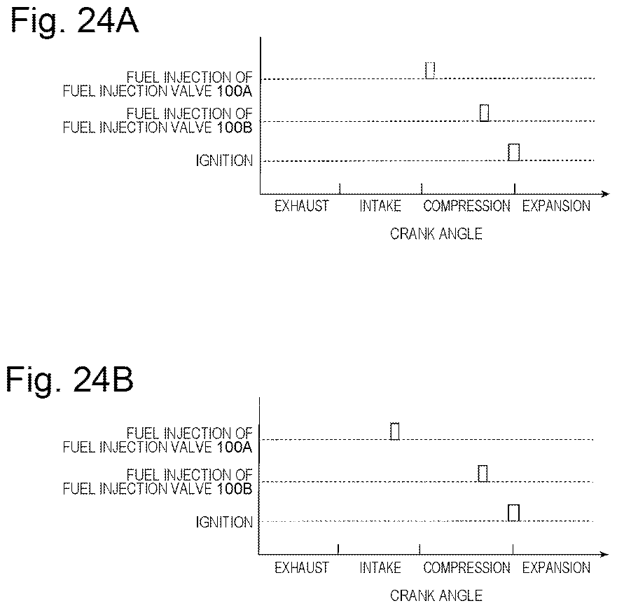

FIGS. 24(a) and 24(b) illustrate other examples of the injection form of the cold start mode according to the present embodiment.

FIG. 24(a) illustrates an example in which the fuel injection in the first half of the compression stroke using the fuel injection valve 100A is added to the fuel injection in the latter half of the compression stroke using the fuel injection valve 100B. FIG. 24(b) illustrates an example in which the fuel injection in the intake stroke using the fuel injection 100A is added to the fuel injection in the latter half of the compression stroke using the fuel injection valve 100B.

For example, even under a cold condition, when the temperature is relatively high or when the fuel vaporization is good due to light fuel, a degree of stratification of the air-fuel mixture is weakened, and it is necessary to optimize the fuel injection such that the air-fuel ratio near the ignition plug 4 is not excessively rich. In such a case, it is effective to disperse the fuel injection in the first half of the compression stroke and the intake stroke as in the examples illustrated in FIGS. 24 (a) and 24(b).

In this case, the fuel injection in the first half of the compression stroke or the intake stroke may be executed by the fuel injection valve 100B, but the fuel injection in the first half of the compression stroke or the intake stroke may be executed by the fuel injection valve 100A in order to prevent the injection hole of the fuel injection valve 100A from being blocked by the combustion deposit. That is, it is more desirable that the fuel injection in the latter half of the compression stroke and the fuel injection in the first half of the compression stroke or the intake stroke are executed by a different fuel injection valve.

Although it has been described in the embodiment that the fuel injection in the latter half of the compression stroke is the single injection, the fuel injection in the latter half of the compression stroke may be the division injection (see FIG. 15(a)).

As described above, the ECU (control device) 120 of the second embodiment includes the CPU 130 that controls the fuel injection valves 100A and 100B which inject the fuel into the cylinder of the engine 30. The CPU 130 includes the fuel injection control unit that injects the fuel (with the first injection rate) by operating the fuel injection valve 100A having the high injection rate in the warm state in which the temperature of the engine 30 is higher than the set temperature, and injects the fuel (with the second injection rate lower than the first injection rate) by operating the fuel injection valve 100B having the low injection rate in the cold state in which the temperature of the engine 30 is lower than the set temperature at the same fuel pressure as that in the warm state.

In other words, unlike the first embodiment described above, the two fuel injection valves 100A and 100B having different injection rates in the case of the same lift amount are attached to the engine 30, and the fuel injection control unit of the CPU 130 operates the fuel injection valve 100B having the low injection rates of the two injection rates 100A and 100B when the fuel is injected with the second injection rate (relatively low injection rate) as the injection rate of the fuel injection valve.

As stated above, the fuel injection is executed by setting the injection rate in the cold state to be lower (smaller) than that in the warm state. Thus, as in the first embodiment, it is possible to suppress the formation of the fuel liquid film that causes the emission of the unburned hydrocarbons and soot in the cold start mode of the engine, and it is possible to achieve both the improvement of the startability and the reduction of the emission at the cold start of the engine.

The fuel injection control unit of the CPU 130 injects the fuel by operating the fuel injection valve 100B at least in the latter half of the compression stroke in the cold state at the same fuel pressure as that in the warm state.

Accordingly, as in the first embodiment, it is possible to reliably form the stratified air-fuel mixture with high ignitability by injecting the fuel in the latter half of the compression stroke while suppressing the formation of the fuel liquid film that causes the emission of the unburned hydrocarbons and soot in the cold start mode of the engine, and it is possible to achieve both the improvement of the startability and the reduction of the emission at the cold start of the engine.

The fuel injection valve in the above-described embodiment is not limited to the solenoid drive type fuel injection valve, and may be a piezo drive type, a magnetostrictive element drive type, or the like.

While the embodiment of the present invention has been described in detail, the present invention is not limited to the aforementioned embodiment, and various changes may be made without departing from the spirit of the present invention described in the claims.

The present invention is not limited to the aforementioned embodiments, and includes various modification examples. For example, the aforementioned embodiments are described in detail in order to facilitate easy understanding of the present invention, and are not limited to necessarily include all the described components. Some of the components of a certain embodiment can be substituted into the components of another embodiment, and the components of another embodiment can be added to the component of a certain embodiment. In addition, other components can be added, removed, and substituted to, from, and into some of the components of the aforementioned embodiment.

In addition, a part or all of the aforementioned configurations, functions, processing units, and processing means may be realized by hardware by designing an integrated circuit, for example.

Each of the aforementioned configurations and functions may be realized by software by interpreting and executing a program that realizes each function by the processor. Information of programs, tables, and files for realizing the functions can be stored in a storage device such as a memory, a hard disk, or a solid state drive (SSD), or a recording medium such as an IC card, an SD card, or a DVD.

Furthermore, control lines and information lines illustrate lines which are considered to be necessary for the description, and not all the control lines and information lines in a product are necessarily illustrated. Almost all the configurations may be considered to be actually connected to each other.

### REFERENCE SIGNS LIST

1 engine head
2 cylinder block
3 piston
4 ignition plug
5 intake pipe
6 exhaust pipe
7 intake valve
8 exhaust valve
10 combustion chamber
14 three-way catalyst
15 air-fuel ratio sensor
16 O₂ sensor
17 connecting rod
18 crankshaft
19 crank angle sensor
20 water temperature sensor
21 accelerator pedal
22 accelerator opening sensor
23 throttle valve
24 low-pressure fuel pipe
25 fuel tank
26 low-pressure pump
27 high-pressure pump
28 high-pressure fuel pipe
29 fuel temperature sensor
30 engine (internal combustion engine)
100,100A,100B,100C fuel injection valve
101 nozzle body
101a seat portion
101b throttle portion
104 needle valve
104a fuel flow path
105 solenoid
119 injection hole
119a injection hole (first injection hole)
119b injection hole (second injection hole)
120 ECU (control device)
121,121A,121B drive device
122,123,124,125 communication line
130 CPU
131 ROM
132 RAM
133 input circuit
134 output circuit

1. A control device comprising
a CPU that controls a fuel injection valve which injects fuel into a cylinder of an internal combustion engine,
wherein the CPU includes a fuel injection control unit that injects the fuel with a first injection rate as an injection rate of the fuel injection valve in a warm state in which a temperature of the internal combustion engine is equal to or higher than a set temperature, and injects the fuel with a second injection rate lower than the first injection rate as the injection rate of the fuel injection valve in a cold state in which the temperature of the internal combustion engine is lower than the set temperature at the same fuel pressure as a fuel pressure in the warm state.

2. The control device according to claim 1, wherein the fuel injection control unit of the CPU injects the fuel with the second injection rate as the injection rate of the fuel injection valve at least in a latter half of a compression stroke in the cold state at the same fuel pressure as the fuel pressure in the warm state.

3. The control device according to claim 1, wherein the fuel injection control unit of the CPU injects the fuel with the second injection rate as the injection rate of the fuel injection valve in a range in which at least a crank angle is from 90° to 0° before a compression top dead center in the cold state at the same fuel pressure as the fuel pressure in the warm state.

4. The control device according to claim 2, wherein the fuel injection control unit of the CPU disperses fuel injection in a latter half of a compression stroke in a first half of the compression stroke or an intake stroke.

5. The control device according to claim 4, wherein the fuel injection control unit of the CPU executes the fuel injection in the latter half of the compression stroke and the fuel injection in the first half of the compression stroke or the intake stroke by different fuel injection valves.

6. The control device according to claim 1, wherein the fuel injection valve is configured to be able to switch a maximum lift amount of a needle valve that opens and closes an injection hole from which the fuel is injected, and the fuel injection control unit of the CPU lifts the needle valve with a smallest maximum lift amount when the fuel is injected with the second injection rate as the injection rate of the fuel injection valve.

7. The control device according to claim 6, wherein the fuel injection valve includes the needle valve provided in a nozzle body, a seat portion at which a fuel flow path is blocked by seating the needle valve at a first protrusion portion provided at an inner wall of the nozzle body, a throttle portion provided such that a diameter of a circle formed by a ridgeline of a second protrusion portion provided at the inner wall of the nozzle body on a downstream side of the seat portion is smaller than a diameter of a circle formed by a ridgeline of the first protrusion portion, a first injection hole disposed between the seat portion and the throttle portion, and a second injection hole disposed on a downstream side of the throttle portion.

8. The control device according to claim 6, wherein the fuel injection valve is configured such that the number of effective injection holes from which the fuel is injected becomes large as the lift amount of the needle valve becomes large.

9. The control device according to claim 1, wherein two fuel injection valves having different injection rates in the case of the same lift amount are attached to the internal combustion engine, and the fuel injection control unit of the CPU operates the fuel injection valve having a low injection rate of the two fuel injection valves when the fuel is injected with the second injection rate as the injection rate of the fuel injection valve.

10. The control device according to claim 1, wherein the fuel injection control unit of the CPU injects the fuel while maintaining the second injection rate as the injection rate of the fuel injection valve constant in a latter half of a compression stroke of one combustion cycle.

11. The control device according to claim 1, wherein the fuel injection control unit of the CPU injects the fuel multiple number of times with the second injection rate as the injection rate of the fuel injection valve at least in a latter half of a compression stroke of one combustion cycle.

12. The control device according to claim 1, wherein the fuel injection control unit of the CPU changes the injection rate of the fuel injection valve or the number of injection divisions based on a cooling water temperature or a lubricating oil temperature of the internal combustion engine.

13. The control device according to claim 12, wherein the fuel injection control unit of the CPU sets the injection rate of the fuel injection valve to be high or sets the number of injection divisions of the fuel injection valve to be small as the cooling water temperature or the lubricating oil temperature of the internal combustion engine becomes high.

14. A control device comprising
a CPU that controls a fuel injection valve which injects fuel into a cylinder of an internal combustion engine,
wherein the CPU includes a fuel injection control unit that injects the fuel with a first injection rate as an injection rate of the fuel injection valve in a warm state in which a temperature of the internal combustion engine is equal to or higher than a set temperature, and injects the fuel multiple number of times with a second injection rate lower than the first injection rate as the injection rate of the fuel injection valve in a latter half of a compression stroke in a cold state in which the temperature of the internal combustion engine is lower than the set temperature at the same fuel pressure as a fuel pressure in the warm state.

15. A fuel injection valve comprising:
a needle valve that is provided in a nozzle body;
a seat portion at which a fuel flow path is blocked by seating the needle valve at a first protrusion portion provided at an inner wall of the nozzle body;
a throttle portion that is provided such that a diameter of a circle formed by a ridgeline of a second protrusion portion provided at the inner wall of the nozzle body on a downstream side of the seat portion is smaller than a diameter of a circle formed by a ridgeline of the first protrusion portion;
a first injection hole that is disposed between the seat portion and the throttle portion; and
a second injection hole that is disposed on a downstream side of the throttle portion.
